(19) United States
(12) Patent Application Publication
(10) Pub. No.: US 2014/0333404 A1
(43) Pub. Date: Nov. 13, 2014

(54) COIL COMPONENT

(71) Applicant: SAMSUNG ELECTRO-MECHANICS CO., LTD., Suwon-si (KR)

(72) Inventors: Jun Hee BAE, Suwon-si (KR); Sang Moon LEE, Suwon-si (KR); Sung Kwon WI, Suwon-si (KR)

(21) Appl. No.: 14/322,628

(22) Filed: Jul. 2, 2014

(30) Foreign Application Priority Data
May 7, 2013 (KR) 10-2013-0079061

(51) Int. Cl. H01F 27/28; H01F 27/29

(52) U.S. Cl. CPC H01F 27/2804; H01F 27/29
USPC 336/192; 336/200

(57) ABSTRACT

Disclosed herein is a coil component including: an insulating layer containing a ferrite powder and a coil electrode embedded in the insulating layer, in which a particle diameter of the ferrite powder is smaller than a wavelength of light which is used during an exposure process, thereby increasing permeability and improving an impedance characteristic.

This application claims the benefit under 35 U.S.C. Section 119 of Korean Patent Application Serial No. 10-2013-0079061 entitled “Coil Component” filed on Jul. 5, 2013, which is hereby incorporated by reference in its entirety into this application.

### BACKGROUND OF THE INVENTION

1. Technical Field The present invention relates to a coil component, and more particularly, to a coil component made of a high permeability material.

2. Description of the Related Art

A coil component is one of the important passive devices configuring an electronic circuit, along with a resistor and a capacitor, and has been mainly used in a power supply circuit such as a DC-DC converter within an electronic device or has been widely used as a component for removing noise or configuring an LC resonance circuit.

Recently, in particular, as a data amount which is processed within the electronic device is increased, a high-speed signal transmission interface has been adopted, such that a use of the coil component serving as an EMI filter is increased. In particular, among them, a use of a common mode filter for removing a common mode noise generated from a high-speed differential signal line has been gradually increased.

Basically, the performance of the coil component carrying out several functions in addition to a filter may be expected to be improved as the high permeability is increased. However, most of the coil components cannot but have reduced permeability since a periphery of a coil in which a current flows is enclosed by an insulating resin to be insulated from an external circuit.

For example, referring to Patent Document (Korean Patent Laid-Open Publication No. 2010-0129561) describing a common mode filter, an insulating layer is disposed between upper and lower magnetic substrates and has primary and secondary coil electrodes, which are electromagnetically coupled with each other, embedded therein. Therefore, a magnetic flux loop generated from a coil electrode may be formed via the upper and lower magnetic substrates having high permeability.

However, the insulating layer provided between the upper and lower magnetic substrate has low permeability and large magnetic resistance, thereby suppressing a flow of the magnetic flux loop. As a result, an impedance characteristic of the common mode filter may be degraded.

To solve the above problem, Patent Document (Korean Patent Laid-Open Publication No. 2006-0126887 discloses a common mode filter in which a magnetic core is inserted into a center of the insulating layer to provide a magnetic flux path which is continued to the upper magnetic substrate, the magnetic core, and the lower magnetic substrate, thereby increasing the permeability.

However, in order to produce the coil component having the above structure, in addition to the existing process, a process of machining a via hole and a process of inserting the magnetic core into the machined via hole need to be additionally carried out, such that an increase in manufacturing costs may be inevitable and the processes are hardly performed on the small coil components, such that productivity may be largely degraded.

### RELATED ART DOCUMENT

### Patent Document

(Patent Document 1) Patent Document 1: Korean Patent Laid-Open Publication No. 2010-0129561

(Patent Document 2) Patent Document 2: Korean Patent Laid-Open Publication No. 2006-0126887

### SUMMARY OF THE INVENTION

An object of the present invention is to provide a coil component including an insulating layer containing a ferrite powder to prevent performance of the coil component from degrading.

Another object of the present invention is to solve a problem of an increase in costs and a reduction in productivity by providing a coil component which can be manufactured by using the existing process line, in particular, a photolithography process as it is.

According to an exemplary embodiment of the present invention, there is provided a coil component, including: an insulating layer containing a ferrite powder and a coil electrode embedded in the insulating layer, wherein a particle diameter of the ferrite powder is smaller than a wavelength of light which is used during an exposure process.

The ferrite powder may be any one selected from a group consisting of Fe—Ni—Zn, Fe—Ni—Zn—Cu, Fe, Ni, and Fe—Ni and a mixture of at least two thereof.

The particle diameter of the ferrite powder may range from 50 nm to 400 nm.

A content of the ferrite powder may range from 15 wt % to 45 wt %.

The ferrite powder may be contained, being dispersed between wirings of the coil electrode.

The insulating layer may be made of a photosensitive insulating resin.

According to another exemplary embodiment of the present invention, there is provided a coil component, including: a magnetic substrate; an insulating layer disposed on one surface of the magnetic substrate; a coil electrode embedded in the insulating layer; and an external terminal electrically connected to the coil electrode through an extracting electrode, in which the insulating layer contains a ferrite powder having a particle diameter smaller than a wavelength of light which is used during an exposure process.

The external terminals may be disposed on the insulating layer and a magnetic resin complex may be filled between the external terminals.

The magnetic resin complex may contain a ferrite powder having a particle diameter larger than that of the ferrite powder contained in the insulating layer.

The particle diameter of the ferrite powder contained in the magnetic resin complex may range from 25 μm to 40 μm.

The coil electrode may be configured of a primary coil electrode and a secondary coil electrode which are electrically coupled with each other.

The coil electrode may be configured of multi layers of at least two layers which are connected to each other through a via electrode.

### BRIEF DESCRIPTION OF THE DRAWINGS

FIG. 1 is a perspective view of a coil component according to an exemplary embodiment of the present invention.

FIG. 2 is a cross-sectional view taken along the line I-I′ of FIG. 1.

FIG. 3 is a diagram for describing one process of manufacturing the coil component.

### DESCRIPTION OF THE PREFERRED EMBODIMENTS

Various advantages and features of the present invention and methods accomplishing thereof will become apparent from the following description of exemplary embodiments with reference to the accompanying drawings. However, the present invention may be modified in many different forms and it should not be limited to exemplary embodiments set forth herein. These exemplary embodiments may be provided so that this disclosure will be thorough and complete, and will fully convey the scope of the invention to those skilled in the art.

Terms used in the present specification are for explaining exemplary embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

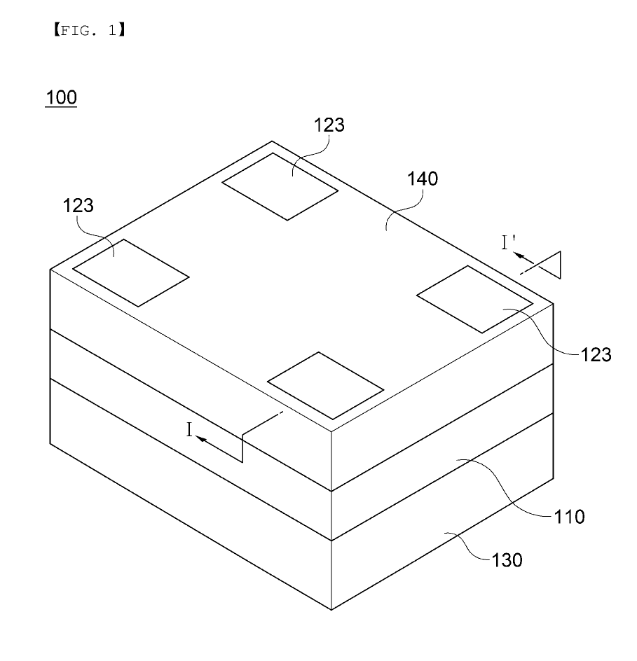

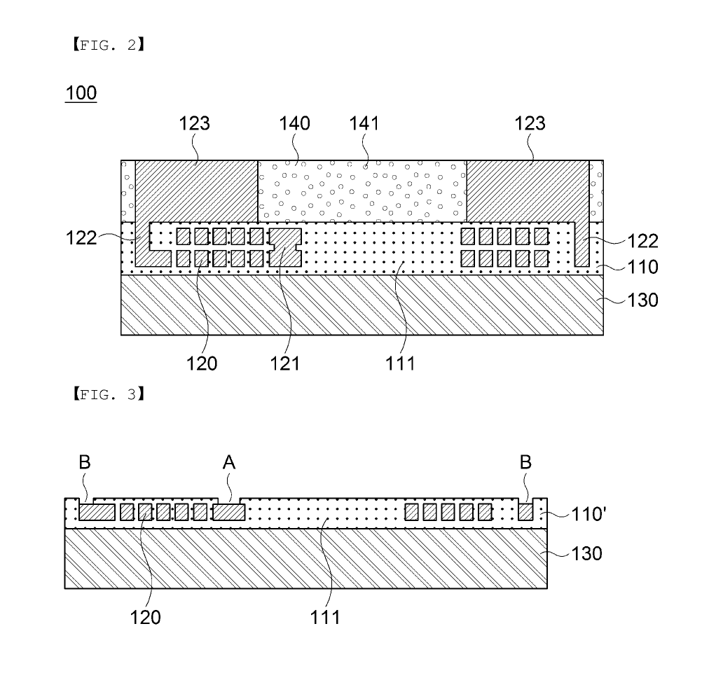

FIG. 1 is a perspective view of a coil component according to an exemplary embodiment of the present invention and FIG. 2 is a cross-sectional view taken along the line I-I′ of FIG. 1. Additionally, components shown in the accompanying drawings are not necessarily shown to scale. For example, sizes of some components shown in the accompanying drawings may be exaggerated as compared with other components in order to assist in the understanding of the exemplary embodiments of the present invention. Meanwhile, throughout the accompanying drawings, the same reference numerals will be used to describe the same components. For simplification and clearness of illustration, a general configuration scheme will be shown in the accompanying drawings, and a detailed description of the feature and the technology well known in the art will be omitted in order to prevent a discussion of exemplary embodiments of the present invention from being unnecessarily obscure.

Referring to FIGS. 1 and 2, a coil component 100 according to an exemplary embodiment of the present invention includes an insulating layer 110 and a coil electrode 120 embedded in the insulating layer 110 as a basic structure.

The coil electrode 120, which is a metal line plated with a spiral coil pattern by using a circuit forming method, such as a subtractive method, an additive method, a semi-additive method, and a modified semi-additive (MSAP) method, may be made of at least one selected from silver (Ag), palladium (Pd), aluminum (Al), nickel (Ni), titanium (Ti), gold (Au), copper (Cu), and platinum (Pt) having excellent electrical conductivity or a mixture of at least two thereof.

The coil electrode 120 is configured of multi layers of at least two layers, thereby increasing a turn number. In this case, the coil electrodes 120 of each layer are spaced apart from each other at a predetermined interval and an interlayer electrical connection may be made through a via electrode 121. FIGS. 1 and 2 illustrate only two layers, but may be configured of at least three layers depending on the required capacity.

Further, the coil electrode 120 is configured of a primary coil electrode and a secondary coil electrode which are electrically coupled with each other, and thus when a current flows between the primary and secondary coil electrodes in the same direction, magnetic fluxes are reinforced with each other to increase a common mode impedance, thereby suppressing a common mode noise and when a current flows in an opposite direction, a magnetic flux is canceled with each other to reduce a differential mode impedance, such that the coil electrode 120 may be operated as a common mode filter which passes through a desired transmission signal.

The coil electrode 120 is electrically connected to an external terminal 123 through an extracting electrode 122 to be able to be applied with an external voltage. That is, the extracting electrode 122 is disposed at a side of the insulating layer 110 and one terminal thereof is connected to an end of the coil electrode 120 and the other terminal thereof is exposed outside the insulating layer 110 to be bonded to the external terminal 123.

In this configuration, the external terminal 123 may be disposed on the insulating layer 110 along an exposed direction of the extracting electrode 122. Unlike one illustrated in the drawings, when the other terminal of the extracting electrode 122 is exposed to the side of the insulating layer 110, the external terminal 123 may also be disposed at a side of the device.

The insulating layer 110 serves to give an insulating property to the coil electrode 120 and protect the coil electrode 120 from impact, moisture, high temperature, and the like, such that a component material thereof may be appropriately selected in consideration of insulating property, heat resistance, moisture resistance, and the like. For example, as an optimal polymer material forming the insulating layer 110, there may be a thermosetting resin, such as epoxy resin, phenol resin, urethane resin, silicon resin, and polyimide resin, a thermoplastic resin, such as polycarbonate resin, acrylic resin, polyacetal resin, and polypropylene resin, and the like.

Herein, the insulating layer 110 may contain a ferrite powder 111 having high permeability. The ferrite powder 111 may use, for example, Fe—Ni—Zn oxides as a soft magnetic material, Fe—Ni—Zn—Cu oxides, and the like, and may additionally use metals, such as Fe, Ni, and Fe—Ni (permalloy) or a mixture thereof.

The ferrite powder 111 may be contained, being dispersed between the wirings of the coil electrode 120, such that the insulating layer 110 according to the exemplary embodiment of the present invention may have the high permeability unlike the general insulating layer according to the related art to serve as a path of the magnetic flux loop, thereby more smoothing the flow of the magnetic flux generated from the coil electrode 120 to increase the impedance characteristic.

In order to more increase the permeability of the insulating layer 110, it is preferable to increase a content of the ferrite powder 111. However, when the content of the ferrite powder 111 is too high, there may be a problem in the insulating property, such that the content of the ferrite powder 111 may be appropriately selected within a range of 15 wt % to 45 wt %. However, since the numerical range is an optimal range set in consideration of the correlation between the insulating property and the permeability, when the numerical range which is slightly deviated from the optimal range meets the object of the present invention, it is apparent to those skilled in the art that the numerical range may be allowed.

The insulating layer 110 may be laminated, putting the magnetic substrate 130 disposed on a lower portion thereof. The magnetic substrate 130 may be made of Ni—Zn ferrite, Mn—Zn-based, Ni—Zn-based, Ni—Zn—Mg-based, and Mn—Mg—Zn-based ferrites, or a mixture thereof, which have a high electrical resistance and a low magnetic force loss and may have easily designed impedance through a composition change.

In addition to this, a magnetic resin complex 140 may be further provided between the external terminals 123. The magnetic resin complex 140 may be formed by filling an epoxy resin having a paste form in which a ferrite powder 141 is formed to be mixed between the external terminals 123, such that the magnetic resin composite 140 serves as the path of the magnetic loop, along with the magnetic substrate 130.

As such, the magnetic flux loop in the coil component 100 according to the exemplary embodiment of the present invention continuously flows through the magnetic substrate 130 and the magnetic resin complex 140 having high permeability and the insulating layer 110 disposed therebetween, thereby largely increasing the impedance characteristic of the coil.

Meanwhile, the insulating layer 110 may be made of a photosensitive insulating resin. Therefore, the insulating layer 110 in which the coil electrode 120 is embedded may be formed by repeatedly carrying out a process of coating the photosensitive insulating resin and a process of plating the coil electrode 120 thereon in a thickness direction. Herein, when the coil electrode 120 is configured of multi layers of at least two layers, as illustrated in FIG. 3, an opening A needs to be formed at a position formed with the via electrode 121 by a photolithography process, in an insulating resin 110′ covering the coil electrode 120 of the lower layer, so as to form the via electrode 121 for the interlayer connection of the coil electrode 120. Further, an opening B also needs to be formed at a position at which the extracting electrode 112 is formed, by the photolithography process.

The photolithography process uses a principle of chemically reacting a photosensitive material when the photosensitive material is irradiated with light so as to change the property of the photosensitive material. In this case, the openings A and B may be formed by carrying out an exposure process of irradiating light only to the portions to be formed with the openings A and B by attaching a mask pattern (not illustrated) on a photosensitive insulating resin 111′ covering the coil electrode 120 of the lower layer and then removing the insulating resin of the portion irradiated with light by using a developer. Further, in addition to the above positive method, a negative method of carrying out the exposure process to irradiate light only to the remaining portion other than the portion to be formed with the openings A and B may be used.

In this case, when a particle size (hereinafter, particle diameter) of the ferrite powder 111 contained in the insulating layer 110 is smaller than a wavelength of light which is used in the exposure process, a diffraction of light is larger at the time of exposure and when light is dispersed by the diffraction, a light absorption rate of the insulating resin 111′ is increased, thereby more smoothly carrying out the photolithography process.

Therefore, according to the exemplary embodiment of the present invention, the particle diameter of the ferrite powder 111 contained in the insulating layer 110 is smaller than the wavelength of light used in the exposure process. In detail, the wavelength of general light used in the exposure process exceeds 400 nm and therefore the particle diameter of the ferrite power 111 may be sets within a range from 50 nm to 400 nm.

As the particle diameter of the ferrite powder 111 is small, the diffraction of light is larger, but the permeability is in proportion to a concentration and a size of the ferrite powder 111, and therefore the particle diameter of the ferrite powder 111 is preferably set to be maximally large within a small range than the wavelength of light which is used during the exposure process.

Meanwhile, in the case of the ferrite powder 141 contained in the magnetic resin complex 140, since a separate exposure process is not carried out at the time of forming the magnetic resin complex 140, the size of the ferrite powder 141 is not limited unlike the ferrite powder 111 contained in the insulating layer 110. However, in order to increase the permeability, the size of the ferrite powder 141 may be configured to have a larger particle than that of the ferrite powder 111 included in the insulating layer 110, in detail, may be set within a range from 25 μm to 40 μm.

Unlike the related art, according to the exemplary embodiments of the present invention, the insulating layer has the high permeability, such that the coil components may show the high impedance characteristic.

Further, the coil component can be manufactured using the existing processes as they are, and as a result, can be manufactured with a high yield without increasing costs.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A coil component, comprising:
an insulating layer containing a ferrite powder; and
a coil electrode embedded in the insulating layer,
wherein a particle diameter of the ferrite powder is smaller than a wavelength of light which is used during an exposure process.

2. The coil component according to claim 1, wherein the ferrite powder is any one selected from a group consisting of Fe—Ni—Zn, Fe—Ni—Zn—Cu, Fe, Ni, and Fe—Ni and a mixture of at least two thereof.

3. The coil component according to claim 1, wherein the particle diameter of the ferrite powder ranges from 50 nm to 400 nm.

4. The coil component according to claim 1, wherein a content of the ferrite powder ranges from 15 wt % to 45 wt %.

5. The coil component according to claim 1, wherein the ferrite powder is contained, being dispersed between wirings of the coil electrode.

6. The coil component according to claim 1, wherein the insulating layer is made of a photosensitive insulating resin.

7. A coil component, comprising:
a magnetic substrate;
an insulating layer disposed on one surface of the magnetic substrate;
a coil electrode embedded in the insulating layer; and
an external terminal electrically connected to the coil electrode through an extracting electrode,
wherein the insulating layer contains a ferrite powder having a particle diameter smaller than a wavelength of light which is used during an exposure process.

8. The coil component according to claim 7, wherein the external terminals are disposed on the insulating layer and a magnetic resin complex is filled between the external terminals.

9. The coil component according to claim 8, wherein the magnetic resin complex contains a ferrite powder having a particle diameter larger than that of the ferrite powder contained in the insulating layer.

10. The coil component according to claim 9, wherein the particle diameter of the ferrite powder contained in the magnetic resin complex ranges from 25 μm to 40 μm.

11. The coil component according to claim 7, wherein the coil electrode is configured of a primary coil electrode and a secondary coil electrode which are electrically coupled with each other.

12. The coil component according to claim 7, wherein the coil electrode is configured of multi layers of at least two layers which are connected to each other through a via electrode.
